(19) United States
(12) Patent Application Publication
(10) Pub. No.: US 2001/0052895 A1
(43) Pub. Date: Dec. 20, 2001

(54) METHOD AND APPARATUS FOR MOUSE POSITIONING DEVICE BASED ON INFRARED LIGHT SOURCES AND DETECTOR

(76) Inventor: DINESH KASHINATH ANVEKAR, NEW DELHI (IN)

Correspondence Address: Michael E Whitham, McGuire Woods LLP, 1750 Tysons Blvd Suite 1800, MCLean, VA, 22102-4215, US

(21) Appl. No.: 09/270,396

(22) Filed: Mar. 16, 1999

(51) Int. Cl. G09G 5/00

(52) U.S. Cl. 345/173

(57) ABSTRACT

Pointer positioning device based on infrared light sources and detectors that is compact, rugged and ergonomically easy to use such as can be used in laptop computers and similar devices. The pointer positioning device fits in the same area as a conventional touch-pad device in a portable computing device. It detects movement in the finger movement area by scanning for shadow information with infrared light sources. This pointing device is superior to existing devices in terms of wear and tear on the touch surface and insensitivity to user's finger condition.

### BACKGROUND OF THE INVENTION

1. Field of the Invention

The present invention generally relates to pointer positioning devices and, more particularly, to an improved pointing device based on infrared light sources and detectors that is compact, rugged and ergonomically easy to use such as can be used in laptop computers and similar devices.

2. Background Description

The conventional mouse is a very useful device for moving the pointer on the computer displays and also for user input. However, for portable computers, it is desirable to provide a small compact input device which can provide the full functionality of the conventional mouse. Ergonomic convenience to the user is a paramount concern. Several types of pointer devices are currently available on different laptops and other portable computers. See S. Zhai, B. A. Smith, and T. Selker, “Improving Browsing Performance: A Study of Four Input Devices for Scrolling and Pointing Tasks,” in Proceedings of INTERACT'97. The 6th IFIP Conference on Human-Computer Interaction, pp. 286-292, 1997; K. Kawachiya and H. Ishikawa, “NaviPoint: An Input Device for Mobile Information Browsing,” Proceedings of Computer-Human Interaction CHI.98, 18-23 Apr. 1998, Los Angeles, pp. 1-8; and Microsoft Corp. Microsoft IntelliMouse Home Page at http://www.microsoft.com/products/hardware/mouse/intellimouse/default.htm.

A simple substitute for the conventional mouse found in earlier laptop computers is a miniature tracker ball which is based on electro-mechanical principles. Lower reliability, difficulty in holding a constant position and wear and tear during usage are the major drawbacks of this device. Another pointer device which is currently provided in IBM and other laptop computers is the TrackPoint® analog input device situated amidst keys on the keyboard. (TrackPoint is a registered trademark of IBM Corp.) See Rutledge, J. D. and Selker, “T Force-to-Motion Functions for Pointing,” in Proceedings of INTERACT '90: The IFIP Conference on Human-Computer Interaction, pp. 701-705, 1990. This device is based on sensing the forces applied by the user's finger in the x and y directions. While this device is quite satisfactory in terms of pointing function, its use requires dexterity on the part of the user. For this reason, some users prefer laptops with other types of pointing devices. Another limitation of this device is that it does not support double-clicking function available with touch-pad type of pointing devices. The touch-pad pointing device is robust and easy to use. The touch-pad pointing device is currently available in many modern laptop computers. Here, the user moves his finger on rectangular area of the touch pad to move the pointer. Although the touch-pad devices typically have one, two and sometimes three “mouse” buttons which allow single and double clicking, single-clicking and double-clicking effects can also be achieved by single and double hitting on the touch pad. Wear and tear of the touch pad and sensitivity to touch by different users or condition of finger are some drawbacks of this device.

### SUMMARY OF THE INVENTION

It is therefore an object of the invention to provide a new type of pointer device which is more robust and superior to some of the existing pointer devices. The present invention is based on infrared (IR) light sources and detectors. It is similar to the existing touch-pad-type of pointing device available on some laptop computers. Instead of relying on surface sensors to detect finger movement on the touch surface, it measures the relative movement by sensing the shadow of the finger in the movement area.

This new pointing device is superior to existing devices because it is independent of touch sensitivity and is more robust. This new pointing device is superior in terms of wear and tear on the touch surface and insensitivity to user's finger condition. Existing touch-pad devices are based on true touch. The touch surface has a sensor beneath it, and is subject to wear. However, in the present invention, the surface on which the finger is moved has no sensors. It just provides a flat surface for supporting the finger during its motion. In this sense, the new touch-pad-like device does not have the wear and tear problem. Also, there are no moving parts in the device according to the invention.

According to a preferred embodiment of the invention, the pointing device comprises an x-direction IR source controller and a y-direction IR source controller and a plurality of x-direction collimated IR light sources and a plurality of y-direction collimated IR light sources. The x and y-direction IR source controllers respectively alternately and sequentially activate the IR light sources in each direction. A plurality of x-direction IR light detectors and a plurality of y-direction IR light detectors receive collimated IR light from corresponding ones of the x-direction and y-direction IR light sources. A movement area of two-dimensions is scanned by the IR light sources such that objects placed in the movement area create shadows detected by said IR light detectors. An x-direction signal processing circuit and a y-direction signal processing circuit respectively receive signals from said x-direction and y-direction IR light detectors producing detector outputs in the x-y directions to be sent to a pointer control circuit controlling a pointer in a screen display area.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of an infrared source based pointing device according to a preferred embodiment of the invention;

FIG. 2 is a timing diagram showing the scan cycle of IR activation and IR detector output;

FIG. 3 is a block diagram showing the finger movement area of FIG. 1 illustrating finger position detection through finger shadow; and

FIGS. 4A and 4B are respectively a plan view and a cross-sectional side view of an exemplary physical implementation of the pointer device according to the invention.

### DETAILED DESCRIPTION OF A PREFERRED EMBODIMENT OF THE INVENTION

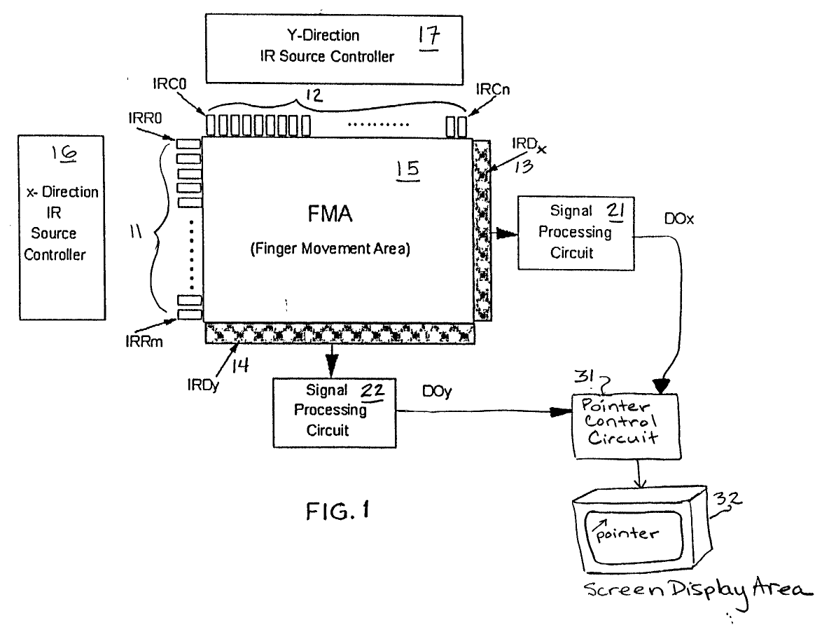

Referring now to the drawings, and more particularly to FIG. 1, there is shown a schematic diagram of the new pointing device. Here, infrared (IR) light sources 11 labeled IRRO-IRRm (IR rows 0 to m) and infrared light sources 12 labeled IRCO-IRCn (IR columns 0 to n) produce collimated beams of IR light in each of the x and y directions, respectively. Each of these sources can be activated separately and independently, preferably in a sequential scanning pattern. The IR light emitted by any of the IR sources 11 or 12 can be detected by the IR detectors 13 and 14 (IRDx and IRDy) placed at respective opposite sides to IR sources 11 and 12 of the rectangular Finger Movement Area (FMA) 15.

During operation, the FMA 15 is continuously scanned by IR light in both x and y directions from the IR lights sources 11 and 12. The x-direction IR source controller 16 sequentially activates the IR sources 11, while the y-direction IR source controller 47 sequentially activates IR sources 12. Although the actual scan rate is not important, it should be high enough to enable the sensing of the fastest change in finger shadow positions. Outputs from IR detectors 13 and 14 are respectively processed by signal processing circuits 21 and 22 which provide outputs to pointer control circuit 31. The pointer control circuit 31 generates the necessary controls for displaying the pointer on a display screen 32, such as a Liquid Crystal Display (LCD) as commonly used in laptop computers.

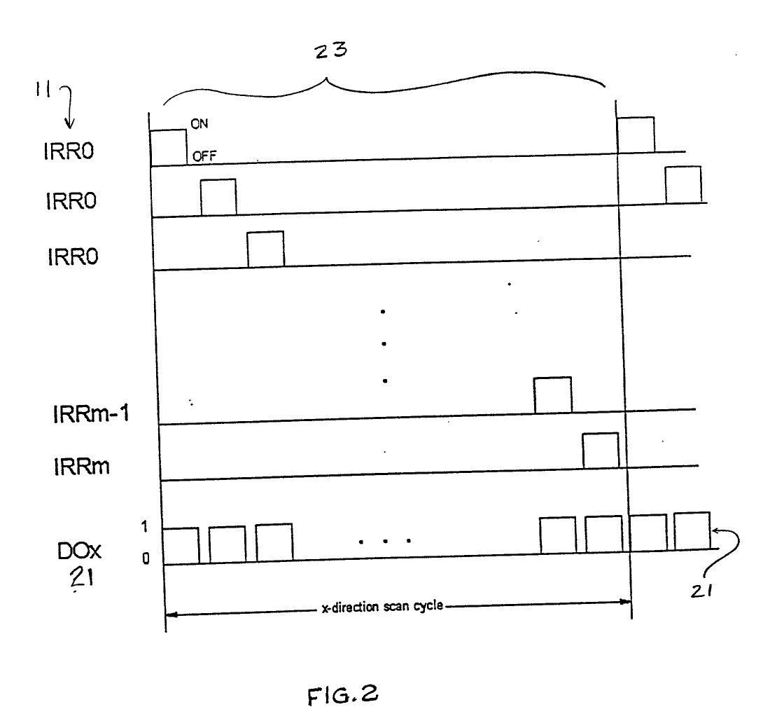

FIG. 2 shows the corresponding activation signals 23 from IR source controller 16 to the IR sources 11 and x-direction detector outputs 21 from IR detectors 13. The signals for the IR source controller 17 to IR sources 12 and the corresponding outputs from the IR detectors 14 are similar and therefore not shown. As seen in FIG. 2, assuming that the IR light is unobstructed in the FMA 15, the IR detector output DOx at 21 is a 1 during all the IR source activation periods.

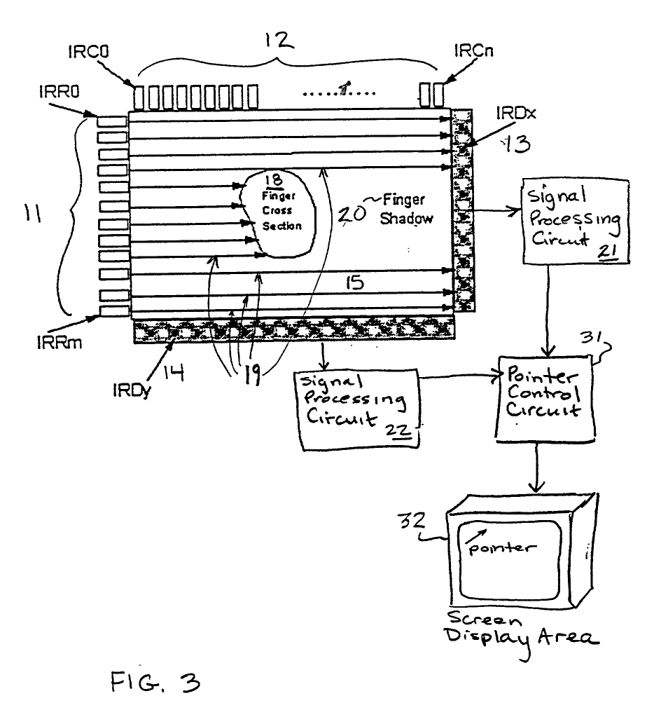

When a user places his finger in the FMA 15, the IR light from some IR sources does not reach the corresponding IR detectors. As an illustration, FIG. 3 shows the situation when a finger 18 is placed in the FMA 15. For simplicity, only x-direction IR rays 19 are shown. Also, a time-integrated picture with all the rays 19 is shown, but in practice, the IR rays are generated sequentially. As is shown in FIG. 3, the placement of the finger produces a shadow 20 on corresponding ones of IR detectors 13. Similarly, a finger shadow (not shown for reasons of simplicity of illustration) is produced on certain ones of IR detectors 14 during the y-direction scan. It is to be noted that x and y direction scans are performed alternately and therefore the reflected rays from the finger falling on IR detectors 13 (and alternatively, IR detectors 14) during x-direction (y-direction) scans are ignored. Now, it is easy to see that after every x-y scan cycle, the 0-bits obtained from IR detectors 13 and 14 provide the information about the finger shadow. In practice, the bits corresponding to finger edges can oscillate between 0 and 1. This fluctuation can be handled by using some sort of hysteresis, or fuzzy logic, or some standard image recognition techniques.

As described above, the shadow 20 of the finger 18 can be detected continuously by observing the IR signal processing circuit outputs 21 and 22. Now, if the finger 18 is moved over the FMA 15, its shadow 20 also moves correspondingly in the x and y directions. The outputs of signal processing circuits 21 and 22 are fed into a pointer control circuit 31 in order to control the pointer movement in a screen display area 32.

For those skilled in the art, it is easy to see that the pointer position can be controlled easily based on the relative movements of the finger shadows. It is possible to change the sensitivity by appropriately scaling the number of bits of shadow movement to the number of pixels of pointer movement. Also, the resolution can be changed by choosing the number of infrared sources 11 and 12 in each direction.

It should also be noted that multiple IR detectors are not required to practice the present invention. One IR detector each in x and y directions is sufficient. Also, while it is possible to use fiber optics with one or two IR sources and split into one or several beams, this embodiment will require a more complicated method for optically switching the IR light to the appropriate fiber output.

As mentioned above, this new technique supports the double clicking function as available in touch pad type of pointing devices. Because it is not easy to distinguish between the placing of a finger to move the pointer and single clicking, single clicking is usually done through one of the “mouse” switches (not shown). Double clicking, however, can be recognized by a short period with no finger shadows occurring between two states with finger shadows.

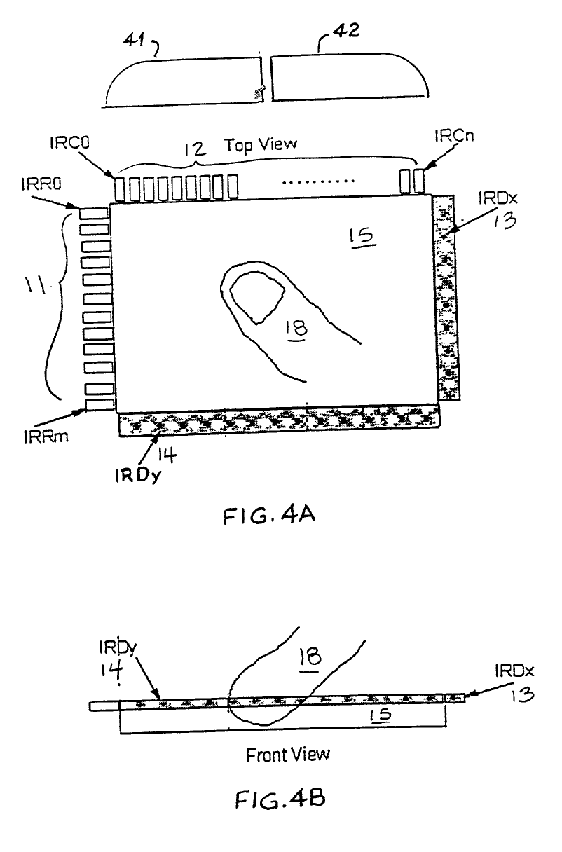

In practice, the new mouse positioning device can be implemented in existing laptop computers and similar devices in the same area as occupied by the touch pad pointing device. FIGS. 4A and 4B show some details about an exemplary physical implementation. FIG. 4A is a plan view showing the mouse movement device comprising the FMA 15, IR light sources 11 and 12, and IR detectors 13 and 14, as in FIG. 1. The IR light sources 11 and 12 and the IR detectors 13 and 14 would not be visible to the user since these would be covered by the keyboard housing. Only the FMA 15 would be exposed by an opening in the keyboard housing. Adjacent the FMA 15 are two “mouse” keys 41 and 42. In the example shown, these “mouse” keys are positioned above the FMA 15 but could also be located just below the FMA 15 or some other convenient location for quick access by the user's finger. As shown in the cross-sectional side view of FIG. 4B, the finger movement area (FMA) 15 is not very deep. One can see that only the tip of the finger 18 is necessary to be placed in the movement area 15 to create a shadow. From the relative sizes of the finger 18, sensors 11 and 12 and the detectors 13 and 14, it can be seen that the entire mouse positioning device will easily fit into the appropriate area of a laptop computer or similar device.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A pointing device for use in computing devices comprising:
means for producing scanned infrared light in first and second dimensions over a movement area;
means for detecting movement of an object in said movement area using shadow information in said first and second dimensions and generating a detector output; and
means for converting the detector output to position information associated with a pointer on a screen display area.

2. A pointing device for use in computing devices as recited in claim 1 wherein means for producing scanned infrared light sequentially generates collimated infrared light beams in each of said first and second dimensions.

3. A pointing device for use in computing devices as recited in claim 2 wherein means for detecting comprises a least one infrared detector for detecting infrared light in said first dimension and at least one infrared detector for detecting infrared light in said second dimension.

4. A pointing device for use in computing devices as recited in claim 1 wherein said movement area is implemented in a laptop computer in an area normally occupied by a touch pad pointing device.

5. A pointing device for use in computing devices comprising:
an x-direction infrared (IR) source controller and a y-direction IR source controller;
a plurality of x-direction collimated IR light sources and a plurality of y-direction collimated IR light sources, said x and y-direction IR source controllers respectively alternately and sequentially activating the IR light sources in each of the x and y-directions;
at least one x-direction IR light detector, and at least one y-direction IR light detector;
a movement area of two-dimensions scanned by said IR light sources such that objects placed in the movement area create shadows detected by said IR light detectors; and
an x-direction signal processing circuit and a y-direction signal processing circuit respectively receiving signals from said x-direction and y-direction IR light detectors producing detector outputs in x-y directions to be sent to a pointer control circuit controlling a pointer in a screen display area.

6. A pointing device for use in computing devices as recited in claim 5 wherein there are fewer IR detectors in each x and y direction than corresponding IR light sources in said x and y directions.

7. A method for detecting movement in a movement area used for positioning pointer on a screen display area comprising the steps of:
producing collimated infrared (IR) light beams in first and second dimensions over a movement area;
detecting movement of an object in said movement area using shadow information in said first and second dimensions; and converting detected movement to position information associated with a pointer on a screen display area.

8. A method for detecting movement in a movement area used for positioning pointer on a screen display area as recited in claim 7 wherein the step of detecting movement is performed using image resolution techniques to resolve edge fluctuations of objects moving in said movement area.

9. A method for detecting movement in a movement area used for positioning pointer on a screen display area as recited in claim 7 wherein the step of converting detected movement to position information produces a desired resolution by choosing a number of infrared sources in each first and second dimension.
